(19) United States
(12) Patent Application Publication
(10) Pub. No.: US 2017/0168419 A1
(43) Pub. Date: Jun. 15, 2017

(54) TONER CARTRIDGE

(71) Applicant: GENERAL PLASTIC INDUSTRIAL CO., LTD., Taichung City (TW)

(72) Inventors: Chin-His CHUANG, Lugang Township (TW); Zheng-Yi XIAO, Taichung City (TW)

(21) Appl. No.: 15/134,690

(22) Filed: Apr. 21, 2016

(30) Foreign Application Priority Data
Dec. 9, 2015 (CN) 201521013884.0

(51) Int. Cl. G03G 15/08

(52) U.S. Cl. CPC G03G 15/0865

(57) ABSTRACT

A toner cartridge includes a cylinder, a transmission member fixedly sleeved onto the cylinder, and a covering member sleeved onto the transmission member. The transmission member has a base pipe portion, a gear ring provided on the periphery of the base pipe portion and engaged with a driving gear of an electronic imaging device, and a protruded portion provided on the periphery of the base pipe portion. The peripheries of the protruded portion and the base pipe portion form a circumferential surface, so that a sensor in the electronic imaging device can sense positional variation of the circumferential surface during rotation of the transmission member. The sensor senses the pass of the protruded portion once in every revolution of the rotation of the transmission member. Therefore, the residual powder in the toner cartridge, which should be replaced according to an alarm of the electronic imaging device, is reduced.

### BACKGROUND OF THE INVENTION

1. Field of the Invention

The present invention relates generally to electronic imaging devices and more particularly, to a toner cartridge used in an electronic imaging device.

2. Description of the Related Art

It is well known that the electronic imaging device, such as a copy machine or a printer, can sense the quantity of the carbon powder remaining in the toner cartridge, determine that the toner cartridge is in the condition of small quantity of carbon powder, free of carbon powder, or in other conditions, and indicate the present condition of the toner cartridge. Besides, the electronic imaging device can stop printing when the toner cartridge is in the condition of free of carbon powder, thereby prevented from breakdown.

For the commercially available electronic imaging devices, the quantity of the remaining carbon powder is sensed in a way that two relatively higher points on the toner cartridge, which are located correspondingly to each other, are sensed by a sensor; when the sensor has sensed the pass of the relatively higher point twice, the toner cartridge has rotated for one revolution. For example, if the predetermined quantity of discharged carbon powder is achieved by ten revolutions of the rotation of the toner cartridge (i.e. the sensor has sensed the pass of the relatively higher point for twenty times), the electronic imaging device determines that there is sufficient quantity of carbon powder in the toner cartridge. However, if the sufficient quantity of discharged carbon powder is achieved by relatively more revolutions of the rotation of the toner cartridge (ex. fifteen revolutions, i.e. the sensor has sensed the pass of the relatively higher point for thirty times), the electronic imaging device determines that the toner cartridge is in the condition of small quantity of carbon powder or free of carbon powder, thereby sending out the alarm for the replacement of the toner cartridge.

However, even though the electronic imaging device sends out the alarm, there may be some carbon powder not discharged but still remaining in the toner cartridge. At this time, if discarding the toner cartridge, it is no doubt a waste.

### SUMMARY OF THE INVENTION

The present invention has been accomplished in view of the above-noted circumstances. It is an objective of the present invention to provide a toner cartridge, when which is discarded, relatively less carbon powder remains therein, resulting in relatively less waste.

To attain the above objective, the present invention provides a toner cartridge which includes a cylinder, a transmission member, and a covering member. The cylinder has an inserting section, and an opening provided at an end of the inserting section. The transmission member has a base pipe portion sleeved onto the inserting section of the cylinder, an extended pipe portion extended from the base pipe portion, a gear ring provided on a periphery of the base pipe portion, a protruded portion provided on the periphery of the base pipe portion, and an end portion provided at a free end of the extended pipe portion and having at least one outlet. The periphery of the protruded portion and the periphery of the base pipe portion are connected together to form a circumferential surface. The transmission member and the cylinder are fixed to each other and capable of rotating together. The covering member is sleeved onto the extended pipe portion of the transmission member and covers the outlet.

When a driving gear provided in an electronic imaging device drives the transmission member and the cylinder to rotate, the positional variation of the circumferential surface can be sensed by a sensor provided in the electronic imaging device. The sensor senses the pass of the protruded portion once in every revolution of the rotation of the transmission member. As a result, when the sensor has sensed the pass of the protruded portion of the transmission member of the present invention for the predetermined number of times (ex. thirty times), which causes the electronic imaging device to determine the carbon powder is insufficient, the actual number of revolutions (i.e. thirty revolutions) of the rotation of the transmission member is the double of that of the conventional toner cartridge. Therefore, the toner cartridge of the present invention can cause the carbon powder provided therein to be discharged more completely, so that relatively less carbon powder will remain in the discarded toner cartridge, resulting in relatively less waste.

### BRIEF DESCRIPTION OF THE DRAWINGS

FIG. 1 is a schematic sectional view of an electronic imaging device and a toner cartridge according to a preferred embodiment of the present invention.

FIG. 2 is an assembled perspective view of the toner cartridge according to the preferred embodiment of the present invention.

FIG. 3 is an exploded perspective view of the toner cartridge according to the preferred embodiment of the present invention.

FIG. 4 is a perspective view of a transmission member according to the preferred embodiment of the present invention.

FIG. 5 is a lateral view of the transmission member according to the preferred embodiment of the present invention.

### DETAILED DESCRIPTION OF THE INVENTION

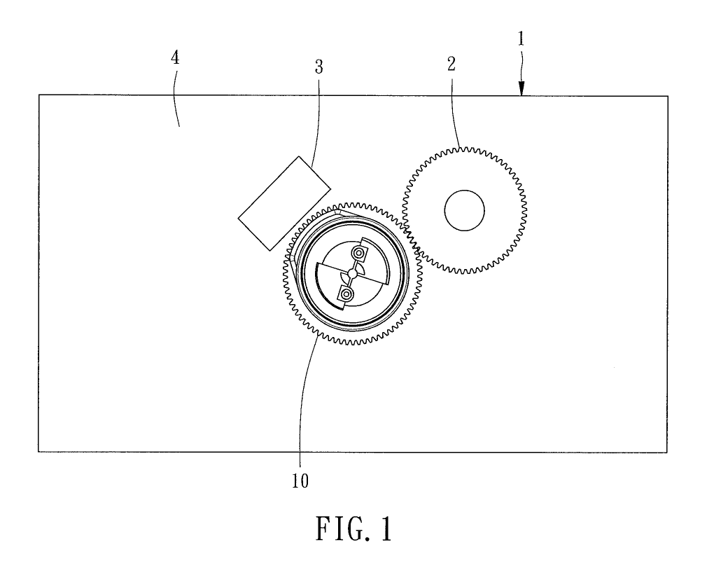

Refer to FIG. 1, which is a schematic sectional view of an electronic imaging device 1, and a toner cartridge 10 disposed in the electronic imaging device 1. The electronic imaging device 1 is provided therein with a driving gear 2, a sensor 3, an accommodating space 4, and other components not shown in the figures. The toner cartridge 10 is accommodated in the accommodating space 4.

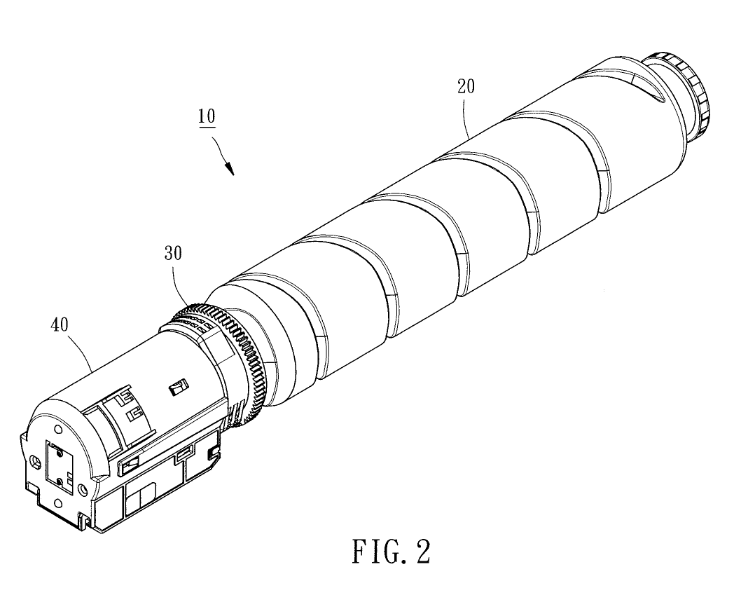

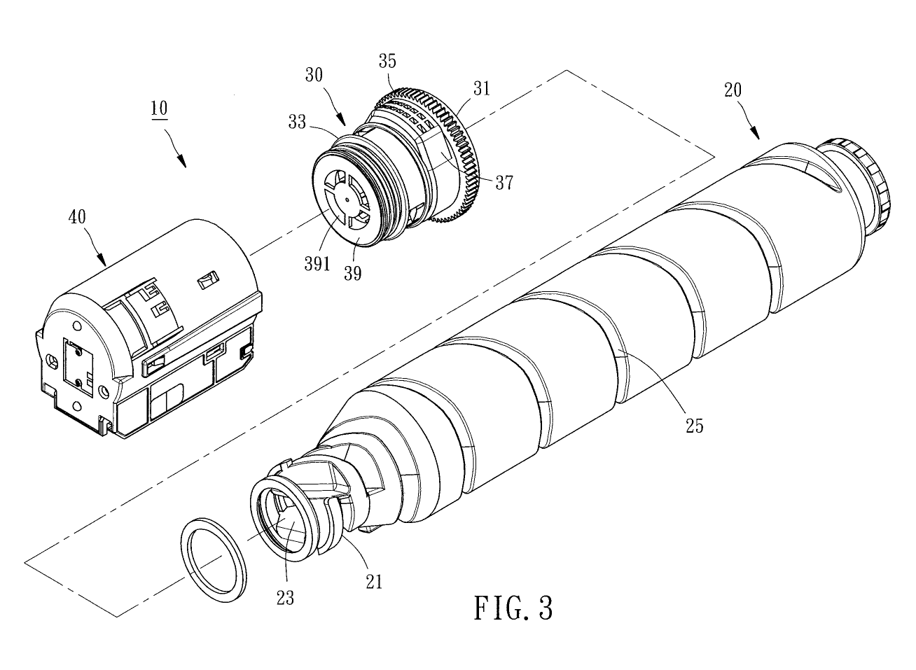

Referring to FIGS. 2-3, the toner cartridge 10 includes a cylinder 20, a transmission member 30, and a covering member 40.

The cylinder 20 has an inserting section 21, an opening 23 provided at an end of the inserting section 21, and a thread 25 concaved from a part of the external surface of the cylinder 20 to the internal space of the cylinder 20. The cylinder 20 is adapted to accommodate carbon powder in the internal space. The opening 23 is provided for carbon powder to pass through.

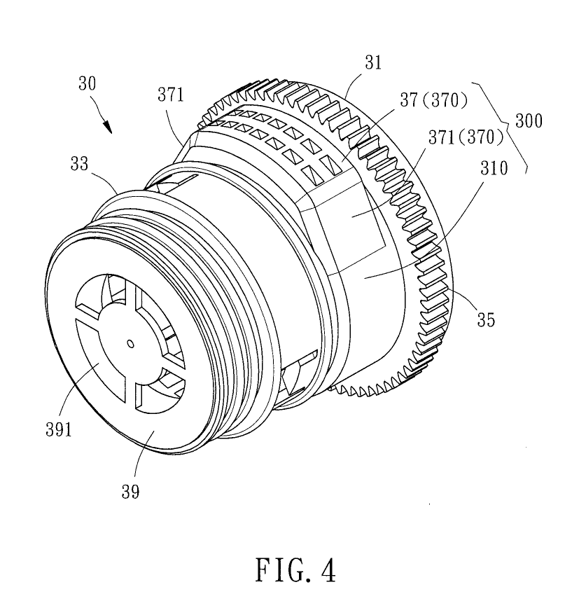

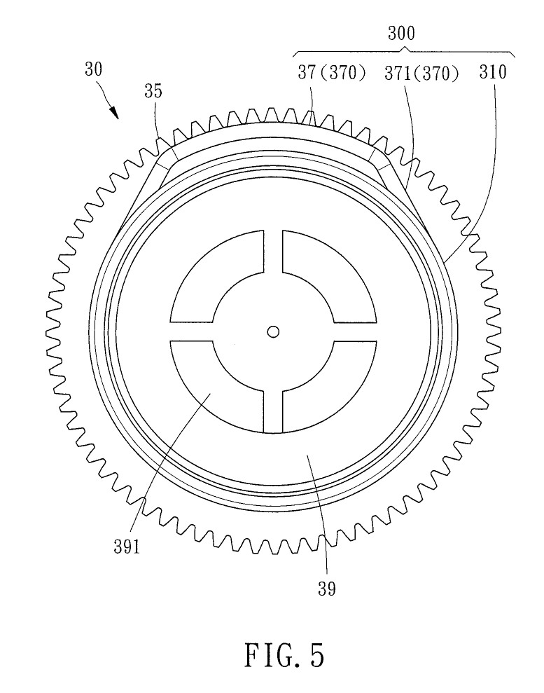

Referring to FIGS. 4-5, the transmission member 30 has a base pipe portion 31, an extended pipe portion 33, a gear ring 35, a protruded portion 37, and an end portion 39. The base pipe portion 31 is sleeved onto the inserting section 21 of the cylinder 20. The extended pipe portion 33 is extended from the base pipe portion 31 to the covering member 40. The gear ring 35 is provided on the periphery 310 of the base pipe portion 31 and adjacent to the cylinder 20, for being engaged with the driving gear 2 of the electronic imaging device 1. The transmission member 30 can be driven to rotate in a way that the gear ring 35 is rotated by the driving gear 2. The protruded portion 37 is provided on the periphery 310 of the base pipe portion 31 and located between the gear ring 35 and the extended pipe portion 33. The protruded portion 37 is provided on two sides thereof with two guiding slopes 371 respectively. The periphery 370 of the protruded portion 37, including the two guiding slopes 371, and the periphery 310 of the base pipe portion 31 are connected together to form a circumferential surface 300. The circumferential surface 300 is not shaped as a circle, but an enclosed circuit. The radius of curvature of the circumferential surface 300 at the protruded portion 37 is larger than that at other parts. The end portion 39 is provided at a free end of the extended pipe portion 33, and has four outlets 391 for carbon powder to pass through. The outlets 391 are located adjacent to the opening 23 of the cylinder 20 so that the outlets 391 communicate with the internal space of the cylinder 20. The transmission member 30 and the cylinder 20 are fixed to each other and capable of rotating together. In other embodiments, the amount of the outlet 391 of the end portion 39 can be modified according to demands.

The covering member 40 is sleeved onto the extended pipe portion 33 of the transmission member 30 and covers the outlets 391. When it is mentioned in the present invention that the covering member 40 covers the outlet 391, it means that the carbon powder passing through the outlet 391 is temporarily preserved in the internal space of the covering member 40, but not moved to other space of the toner cartridge 10. At least a part of the covering member 40 is fixedly engaged with the electronic imaging device 1. The covering member 40 is provided at the bottom side thereof with a powder outlet (not shown).

When the driving gear 2 of the electronic imaging device 1 drives the transmission member 30 and the cylinder 20 to rotate, the covering member 40 is not rotated, and the rotation of the thread 25 causes the carbon powder located in the cylinder 20 to gradually move to the opening 23 of the cylinder 20. The carbon powder leaves the cylinder 20 through the opening 23 to enter the internal space of the covering member 40 through the outlets 391, and then discharged by the toner cartridge 10 through the powder outlet to be used by the electronic imaging device 1. During the rotation of the transmission member 30, the relative position between the aforesaid circumferential surface 300 and the sensor 3 is varied along with the rotation of the transmission member 30, and such positional variation can be sensed by the sensor 3. Specifically speaking, at every time the protruded portion 37 approaches or touches the sensor 3, the protruded portion 37 is sensed by the sensor 3 once. Therefore, the sensor 3 senses the pass or touch of the protruded portion 37 once in every revolution of the rotation of the transmission member 30. Compared with the conventional toner cartridge, which causes the sensor in the electronic imaging device to sense the protruded portion twice in every revolution of the rotation of the transmission member, the toner cartridge of the present invention causes the sensor to sense the protruded portion 37 for only half the number of times of the conventional toner cartridge. As a result, when the sensor 3 has sensed the protruded portion 37 for the predetermined number of times (ex. thirty times), which causes the electronic imaging device 1 to determine the carbon powder is insufficient, the actual number of revolutions (i.e. thirty revolutions) of the rotation of the transmission member 30 is the double of that of the conventional toner cartridge. Therefore, the toner cartridge 10 of the present invention can cause the carbon powder provided therein to be discharged more completely, so that relatively less carbon powder will remain in the discarded toner cartridge 10, resulting in relatively less waste.

Based on the spirit of the present invention, the structure of the toner cartridge may be modified. For example, the location of the protruded portion 37 provided on the transmission member 30 may be closer to the cylinder 20 than the gear ring 35; in such condition, the gear ring 35 is located between the protruded portion 37 and the extended pipe portion 33. The structure and detecting method of the sensor 3 may be modified according to demands, as long as the protruded portion 37 can be sensed by the electronic imaging device 1. For example, the sensor 3 may be a mechanical detecting device, which can sense the touch of the protruded portion 37. Alternately, the sensor 3 may be an optical detecting device, which can sense the protruded portion 37 when the rotating protruded portion 37 passes the sensing area of the optical detecting device. In the condition that the sensor 3 is the mechanical detecting device for touching the protruded portion 37, the protruded portion 37 with the two guiding slopes 371 can provide the sensor 3 a relatively smoother sliding path. In fact, the amount of the guiding slope 371 of the protruded portion can be modified according to the actual condition, and the protruded portion 37 may even have no such guiding slopes 371. The shape of the protrude portion 37 is not limited to that provided in the aforesaid embodiment, as long as the protruded portion 37 can be effectively sensed by the sensor 3.

The above description represents merely the preferred embodiment of the present invention, without any intention to limit the scope of the present invention. The simple variations and modifications not to be regarded as a departure from the spirit of the invention are intended to be included within the scope of the following claims.

What is claimed is:

1. A toner cartridge comprising:
a cylinder having an inserting section, and an opening provided at an end of the inserting section;
a transmission member having a base pipe portion sleeved onto the inserting section of the cylinder, an extended pipe portion extended from the base pipe portion, a gear ring provided on a periphery of the base pipe portion, a protruded portion provided on the periphery of the base pipe portion, and an end portion provided at a free end of the extended pipe portion and having at least one outlet, a periphery of the protruded portion and the periphery of the base pipe portion being connected together to form a circumferential surface, the transmission member and the cylinder being fixed to each other and capable of rotating together; and
a covering member sleeved onto the extended pipe portion of the transmission member and covering the outlet.

2. The toner cartridge as claimed in claim 1, wherein the toner cartridge is adapted to be disposed in an electronic imaging device, which is provided therein with a driving gear, a sensor, and an accommodating space, in a way that the toner cartridge is accommodated in the accommodating space, the gear ring of the transmission member is engaged with the driving gear, and the sensor is capable of sensing positional variation of the circumferential surface during rotation of the transmission member.

3. The toner cartridge as claimed in claim 1, wherein the protruded portion of the transmission member is located between the gear ring and the extended pipe portion.

4. The toner cartridge as claimed in claim 3, wherein the toner cartridge is adapted to be disposed in an electronic imaging device, which is provided therein with a driving gear, a sensor, and an accommodating space, in a way that the toner cartridge is accommodated in the accommodating space, the gear ring of the transmission member is engaged with the driving gear, and the sensor is capable of sensing positional variation of the circumferential surface during rotation of the transmission member.

5. The toner cartridge as claimed in claim 3, wherein the protruded portion of the transmission member is provided on two sides thereof with two guiding slopes.

6. The toner cartridge as claimed in claim 5, wherein the toner cartridge is adapted to be disposed in an electronic imaging device, which is provided therein with a driving gear, a sensor, and an accommodating space, in a way that the toner cartridge is accommodated in the accommodating space, the gear ring of the transmission member is engaged with the driving gear, and the sensor is capable of sensing positional variation of the circumferential surface during rotation of the transmission member.

7. The toner cartridge as claimed in claim 1, wherein the protruded portion of the transmission member is provided on two sides thereof with two guiding slopes.

8. The toner cartridge as claimed in claim 7, wherein the toner cartridge is adapted to be disposed in an electronic imaging device, which is provided therein with a driving gear, a sensor, and an accommodating space, in a way that the toner cartridge is accommodated in the accommodating space, the gear ring of the transmission member is engaged with the driving gear, and the sensor is capable of sensing positional variation of the circumferential surface during rotation of the transmission member.
